(19) United States
(12) Patent Application Publication
(10) Pub. No.: US 2018/0006881 A1
(43) Pub. Date: Jan. 4, 2018

(54) Fault-Tolerant Configuration of Network Devices

(71) Applicant: Microsoft Technology Licensing, LLC, Redmond, WA (US)

(72) Inventors: Parvez Anandam, Seattle, WA (US); Lihua Yuan, Sammamish, WA (US); Sandeep Sheshadri, Kirkland, WA (US); Andrew Mendelsohn, Seattle, WA (US); Shikhar Suri, Bellevue, WA (US)

(21) Appl. No.: 15/198,320

(22) Filed: Jun. 30, 2016

(51) Int. Cl. H04L 12/24; H04L 29/08

(52) U.S. Cl. CPC H04L 41/0806; H04L 67/10; H04L 41/0883; H04L 41/22

(57) ABSTRACT

A process of tracking the lifecycle of a network cluster. A method readies a device for provisioning in a network cluster to place the device in a provision ready state. The method further provisions the device to place the device in an in provision state and when provisioned places the device in an in validation state. The method validates the provisioning of the device by, in parallel, validating the automatic configuration operation of the device and validating the human configuration operation of the device when the device is in the in validation state. When the device is validated, the method changes the device state to a production ready state.

### BACKGROUND

Just-in-time networking requires the frequent addition of capacity in a cloud-computing environment. A unit of capacity, called a network cluster, typically comprises about one hundred network devices, including servers and other hardware. Configuring the network devices in a network cluster includes both human-performed steps, such as cabling, as well as automated steps, such as configuration of the devices. Unfortunately, there is no system for integrating the human steps along with the automated steps. In other words, there is no orchestration of the process of adding capacity that takes into account the human tasks along with the automated tasks. Instead, the human-performed steps are separated from the automated steps. Cabling operations are performed blindly, without any software feedback to the person performing the operation. Also, no parallelization is possible because the entire cabling operation must be performed first before network device configuration can be performed. Thus, the addition of a network cluster for extra capacity can typically take two to three weeks. In addition, the lifecycle state of the network cluster is not tracked.

### SUMMARY

Non-limiting examples of the present disclosure describe a process of tracking the lifecycle of a network cluster. A method readies a device for provisioning in the network cluster to place the device in a provision ready state. The method further provisions the device to place the device in an in provision state and when provisioned places the device in an in validation state. The method validates the provisioning of the device by, in parallel, validating the automatic configuration operation of the device and validating the human configuration operation of the device when the device is in the in validation state. When the device is validated the method changes the device state to a production ready state.

Other non-limiting examples of the present disclosure describe a system for tracking the lifecycle of a network cluster. The system includes: at least one processor; and a memory operatively connected with the at least one processor storing computer-executable instructions that, when executed by the at least one processor, causes the at least one processor to execute a method. The method includes placing a device in a provision-ready state upon designating the device to be provisioned within the network cluster; provisioning the device to place the device in an in provision state and when provisioned placing the device in an in validation state; validating the provisioning of the device by, in parallel, validating the automatic configuration operation of the device and validating the human configuration operation of the device when the device is in the in validation state; and when the device is validated changing the device state to a production ready state.

Other non-limiting examples include a method of tracking the life cycle of a device in a network cluster. The method establishes a plurality of states for a device and places the device in a first state of the plurality of states during installation of the device in the network cluster. The method transitions the device from the first state to a second state of the plurality of states when a first validation action is verified, wherein the first validation action includes human activity. The method transitions the device from the second state to a third state of the plurality of states when a second validation action is verified, wherein the second validation action includes automated activity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a simplified block diagram of a datacenter having network clusters at which aspects of the present disclosure may be directed.

FIG. 2 is a state diagram of a life cycle management system with which aspects of the present disclosure may be practiced.

FIG. 3 is a diagram illustrating transition between InValidation state and ProductionReady state of a life cycle management system with which aspects of the present disclosure may be practiced.

FIG. 4 is an exemplary user interface screen of a life cycle management system with which aspects of the present disclosure may be practiced.

FIG. 5 is a second exemplary user interface screen of a life cycle management system with which aspects of the present disclosure may be practiced.

FIG. 6 is a block diagram illustrating example physical components of a computing device with which aspects of the disclosure may be practiced.

FIGS. 7A and 7B are simplified block diagrams of a mobile computing device with which aspects of the present disclosure may be practiced.

### DETAILED DESCRIPTION

Examples disclosed herein describe systems and methods for tracking the lifecycle of a network cluster and integrating the human performed operations with the automated operations during installation of the network cluster in a life cycle management system. The method may eliminate errors by incorporating human operations, such as cabling of devices, with configuration of devices into an automated workflow. The method may enable large scale fault-tolerant configuration. In order to accomplish this, the method may track the life cycle of devices in a network cluster on a device-by-device basis. The status of a device in a network cluster may be tracked to determine its status, e.g.: device purchased but not in data center; device ready for provisioning; device physically in the data center; device properly provisioned; device in validation; device production ready; device in production; and device in repair. The method and system may automatically monitor for the appearance of a new network cluster in the data center, and human intervention may not be required to start the life cycle management system. Accessibility of the devices in the network cluster may be polled on a regular basis, and they may be configured in parallel to the human operation of cabling. A visual dashboard of the overall progress may be presented to the datacenter as well as to remote personnel expert in networking. After final validation, the network cluster may be declared built.

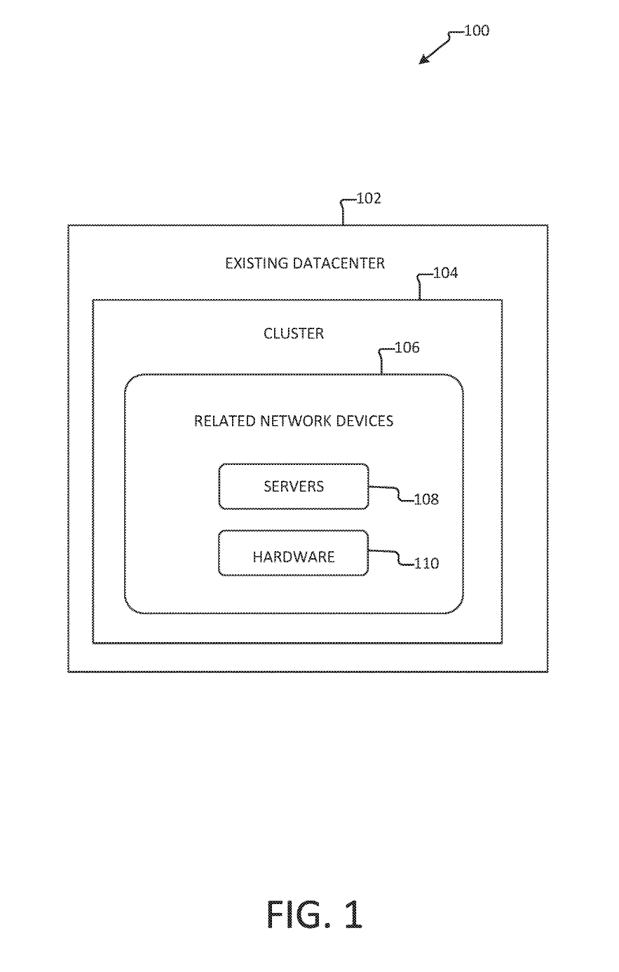

FIG. 1 is a simplified block diagram of a datacenter having network clusters at which aspects of the present disclosure may be directed. A computing system 100 is illustrated that may include one or more datacenters 102. A network cluster 104 may be added to the datacenter. A network cluster 104 typically includes approximately 100 devices 106, including servers 108 and other hardware 110. The focus of this disclosure is on the automation of the addition of a network cluster 104 to a datacenter 102.

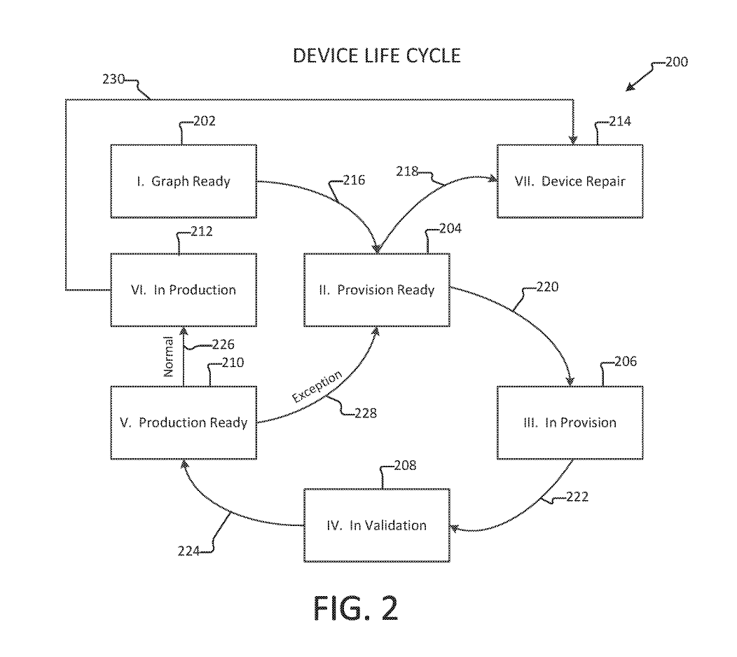

FIG. 2 is a state diagram of a life cycle management system with which aspects of the present disclosure may be practiced. A life cycle management system 200 may track the life cycle of devices in a new network cluster over the course of installation of the network cluster. Using the system and methods disclosed, the network cluster may be installed in a matter of hours or days compared to the two to three weeks it would take in the absence of the methods disclosed. The life cycle management system 200 may track each device in the network cluster on a device-by-device basis during the course of installation of the network cluster. The various states of each device will now be described. When the device is in the GraphReady state 202, the device may have been purchased, but it is not yet installed in the datacenter. The system simply knows that the device has been purchased with the intent that it be installed in the new network cluster. Once a basic checklist of items is complete 216, the state of the device will transition to ProvisionReady state 204. In ProvisionReady state 204, the device is now ready for the provisioning process and is placed into a provisioning queue. When the device is brought out of the queue 220, the device transitions to the InProvision state 206. During this state the device is physically in the data center.

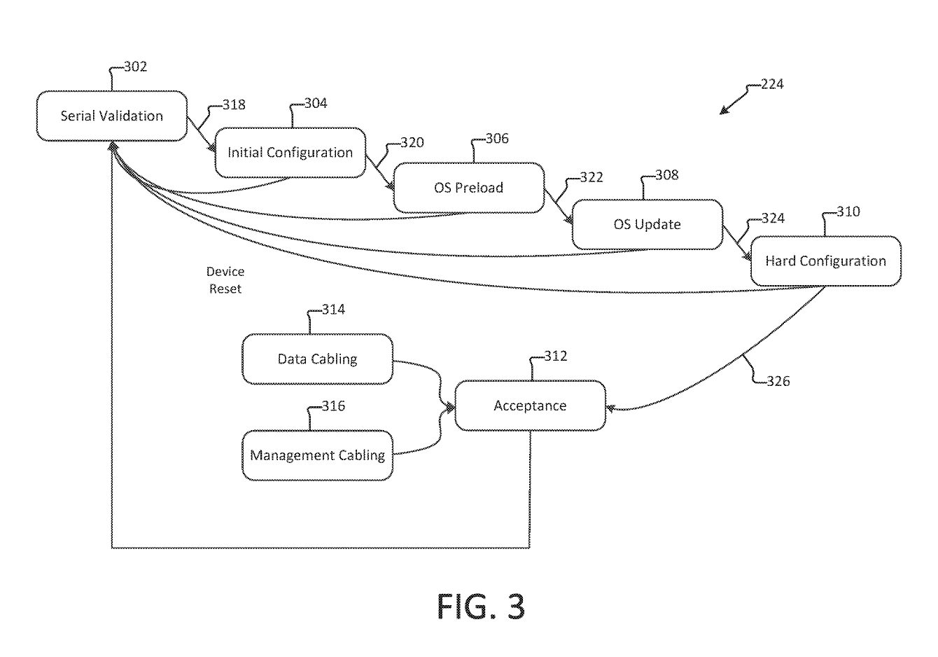

When the device has been completely provisioned and the configuration is correct 222, the device state transitions to the InValidation state 208. In the InValidation State 208, the state of the device is ready to be validated. In other words, it is ready to be checked to see if, for example, the data cabling is proper, the management devices are connected, and loopback checks may be made. If the device passes the InValidation stage 208 by passing the tests 224 (to be described in more detail with respect to FIG. 3), the device is declared production ready and the state is changed to ProductionReady 210. Once the device goes into production 226, the device state is changed to InProduction state 212. Should the device require repair or replacement 230, the state of the device will change to Device Repair state 214 and will remain in that state until the device has been repaired or replaced 218, after which its state may transition back to ProvisionReady state 204.

FIG. 3 is a diagram illustrating transition between InValidation state 208 and ProductionReady state 210 of a life cycle management system with which aspects of the present disclosure may be practiced. In order for the device state to transition between the InValidation state 208 and the ProductionReady state 210, a checklist of actions may occur. While these are described below with respect to a particular order, no particular order is needed for this checklist 224. The serial number for the device may be validated 302. If the serial number of the device is validated 318, the initial configuration for the device may be validated 304. After validating the initial configuration of the device 320, a check may be made to see if the operating system has been installed on the device 306. If the operating system has been installed on the device 322, a check may be made to determine if the operating system has been updated 308. If the operating system has been updated 324, a check may be made to determine if the hardware has been properly configured 310.

In parallel with these automatic tests and configurations, a check is made to determine if the data cabling 314 and the management cabling 316 has been properly installed by the human operators. If all of the above checklists pass, the device is accepted 312 and the transition to the ProductionReady state 210 occurs. Those skilled in the art after reading this disclosure will appreciate that the checklist can be expanded or contracted as appropriate for various devices in the network cluster. In other words, fewer or additional checklist items may be included. It is worth noting that the checklist illustrated in FIG. 3 has the automated tasks checked in parallel with the human tasks.

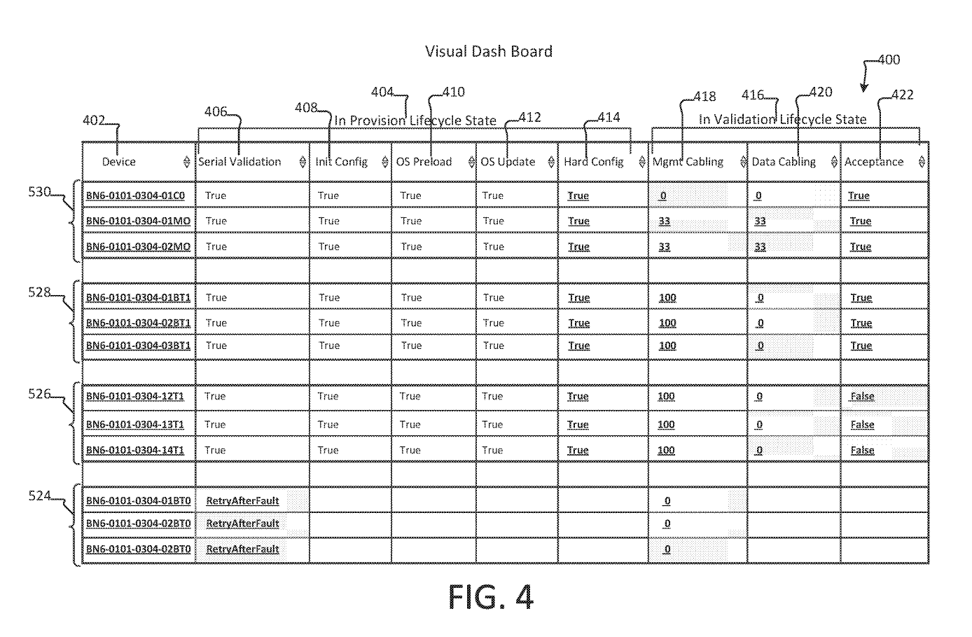

FIG. 4 is an exemplary user interface screen of a life cycle management system with which aspects of the present disclosure may be practiced. The user interface screens serve as a dashboard to let the network managers know the state of an overview of the network cluster, as well as the state of each individual device in the network cluster. FIG. 4 illustrates the visual dash board overview 400 of the network cluster being added. The status of those items to be handled in the InProvision state are shown in the columns under In Provision 404 and those items to be handled in the InValidation state are shown in the columns under In Validation 416. These statuses may be shown for each device 402 in the new network cluster. Each row in the overview 400 represents one device. For each device, the provisioning status may be shown. For example, the serial validation 406, the initial configuration 408, the operating system loaded 410, the operating system updated 412, and the hardware configured 414 may be shown as being true or false. For each device the validation status may be shown. For example, the management cabling 418, data cabling 420, and acceptance 420 may each be shown. For management cabling 418 and data cabling 420 the percentage of the device cabled may be indicated, while for the acceptance 420 a true or false state may be shown. Those skilled in the art after reading this disclosure will appreciate that the items in this overview may be expanded or contracted depending on what checklist items are checked and what a user may want to see in the overview.

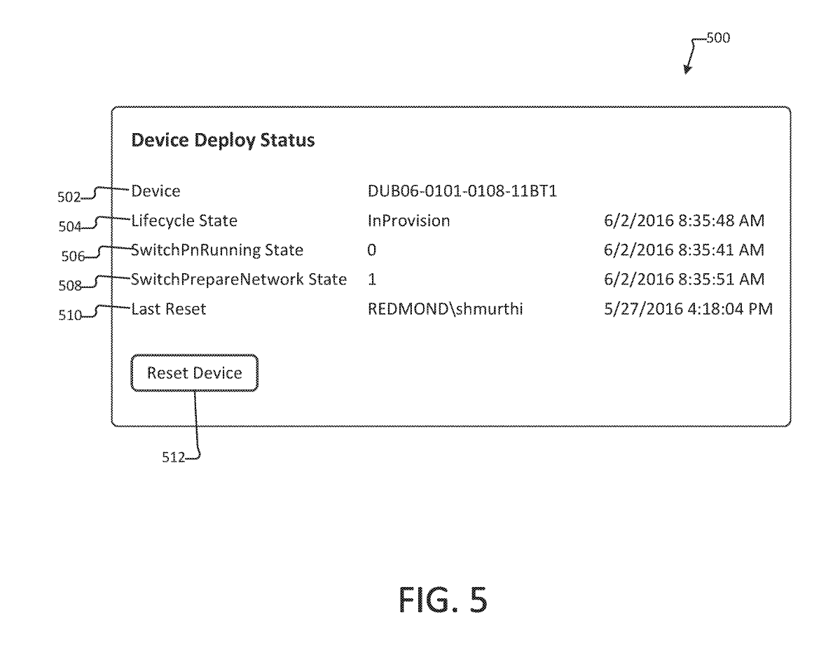

FIG. 5 is a second exemplary user interface screen of a life cycle management system with which aspects of the present disclosure may be practiced. This second user interface screen 500 may be displayed if a user selects a device in column 402 for display of further detail. If further details is requested, screen 500 may present: the serial number 502 of the device selected; the lifecycle state 504 of the device selected; the run state 506 of the device as a 0 or a 1; the network state 508 of the device; and the identity 510 of who last reset the device. For each of these displays an associated date and time of last update may also be displayed. In addition, a reset button 512 may be provided to reset the device.

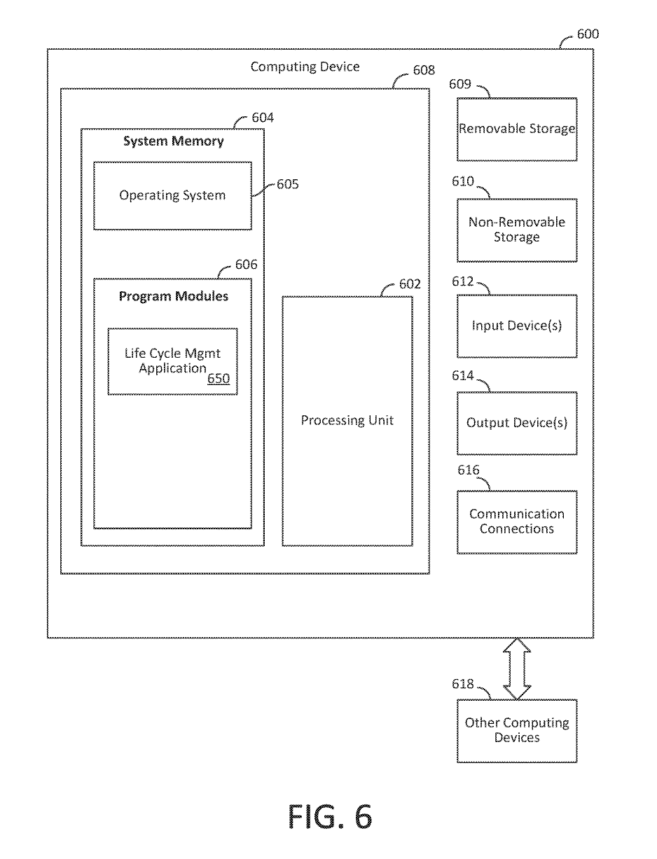

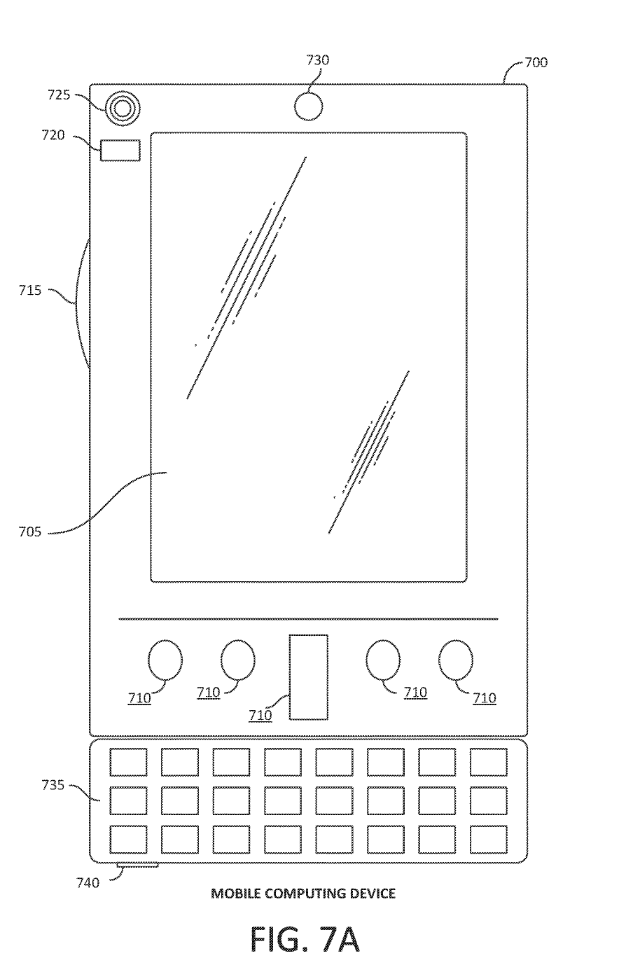

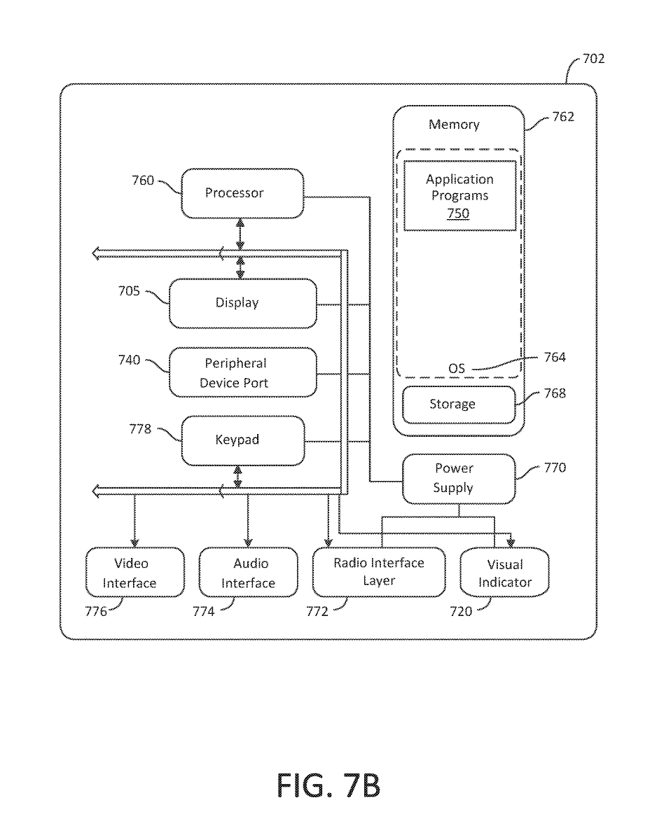

FIGS. 6-7 and the associated descriptions provide a discussion of a variety of operating environments in which aspects of the disclosure may be practiced. However, the devices and systems illustrated and discussed with respect to FIGS. 6-7 are for purposes of example and illustration and are not limiting of a vast number of computing device configurations that may be utilized for practicing aspects of the disclosure, as described herein

FIG. 6 is a block diagram illustrating physical components (e.g., hardware) of a computing device 600 with which aspects of the disclosure may be practiced. The computing device components described below may have computer executable instructions for implementing a life cycle management application 650 on a computing device, including computer executable instructions that can be executed to implement the methods disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running life cycle management application 650, such as one or more components with regard to FIG. 2.

The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., life cycle management application 650) may perform processes including, but not limited to, the aspects, as described herein. Other program modules that may be used in accordance with aspects of the present disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 7A and 7B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 800 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 868 within the memory 762. The non-volatile storage area 768 may be used to store persistent information that should not be lost if the system 702 is powered down. The application programs 766 may use and store information in the non-volatile storage area 768, such as email or other messages used by an email application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions for providing a document history interface as described herein (e.g., life cycle management application).

The system 702 has a power supply 770, which may be implemented as one or more batteries. The power supply 770 may further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 866 via the operating system 764, and vice versa.

The visual indicator 720 may be used to provide visual notifications, and/or an audio interface 774 may be used for producing audible notifications via an audio transducer 725 (e.g., audio transducer 725 illustrated in FIG. 7A). In the illustrated embodiment, the visual indicator 720 is a light emitting diode (LED) and the audio transducer 725 may be a speaker. These devices may be directly coupled to the power supply 770 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 876 that enables an operation of peripheral device 730 (e.g., on-board camera) to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

As should be appreciated, FIGS. 7A and 7B are described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
readying a device for provisioning in a network cluster to place the device in a provision ready state;
provisioning the device to place the device in an in provision state and, when provisioned, placing the device in an in validation state;
validating the provisioning of the device by, in parallel, validating the automatic configuration operation of the device and validating the human configuration operation of the device when the device is in the in validation state; and
when the device is validated, changing the device state to a production ready state.

2. The method of claim 1, further comprising, prior to placing the device in a provision ready state, placing the device in a graph ready state when the device has been purchased for the network cluster but not yet ready for provisioning.

3. The method of claim 2, further comprising transitioning the device from the graph ready state to the provision ready state when the device is received at the data center.

4. The method of claim 1, further comprising transitioning the device from a production ready state to an in production state when the device goes live in the network cluster.

5. The method of claim 1, further comprising transitioning the device from an in production state to a device repair state when the device needs to be repaired.

6. The method of claim 5, further comprising transitioning the device from a device repair state to a provision ready state following repair of the device.

7. The method of claim 1, further comprising displaying the device state to a user.

8. The method of claim 7, wherein displaying the device state further comprises displaying one or more validation statuses and one or more provisioning statuses to the user.

9. A system comprising:
at least one processor; and
a memory operatively connected with the at least one processor storing computer-executable instructions that, when executed by the at least one processor, causes the at least one processor to execute a method that comprises:
placing a device in a provision-ready state upon designating the device to be provisioned within a network cluster;
provisioning the device to place the device in an in provision state and when provisioned placing the device in an in validation state;
validating the provisioning of the device by, in parallel, validating the automatic configuration operation of the device and validating the human configuration operation of the device when the device is in the in validation state; and
when the device is validated changing the device state to a production ready state.

10. The system of claim 9, wherein the method, executed by the at least one processor, further comprises, prior to placing the device in a provision ready state, placing the device in a graph ready state when the device has been purchased for the network cluster but not yet ready for provisioning.

11. The system of claim 10, wherein the method, executed by the at least one processor, further comprises transitioning the device from the graph ready state to the provision ready state when the device is received at the data center.

12. The system of claim 9, wherein the method, executed by the at least one processor, further comprises transitioning the device from a production ready state to an in production state when the device goes live in the network cluster.

13. The system of claim 9, wherein the method, executed by the at least one processor, further comprises transitioning the device from an in production state to a device repair state when the device needs to be repaired.

14. The system of claim 13, wherein the method, executed by the at least one processor, further comprises transitioning the device from a device repair state to a provision ready state following repair of the device.

15. The system of claim 9, wherein the method, executed by the at least one processor, further comprising displaying the device state to a user.

16. The system of claim 15, wherein displaying the device state further comprises displaying one or more validation statuses and one or more provisioning statuses to the user.

17. A method, comprising:
establishing a plurality of states for a device;
placing the device in a first state of the plurality of states during installation of the device in a network cluster; and
transitioning the device from the first state to a second state of the plurality of states when a first validation action is verified, wherein the first validation action includes human activity; and
transitioning the device from the second state to a third state of the plurality of states when a second validation action is verified, wherein the second validation action includes automated activity.

18. The method of claim 17, further wherein the validation and verification actions relating to human activity and the validation and verification actions relating to an automated activity occur parallel.

19. The method of claim 17, further comprising displaying the state for the device to a user.

20. The method of claim 17, wherein at least one of the states is an in validation state.
